(19) United States
(12) Patent Application Publication
(10) Pub. No.: US 2021/0114888 A1
(43) Pub. Date: Apr. 22, 2021

(54) HIGHLY DISPERSIBLE PRECIPITATED SILICAS

(71) Applicant: WACKER CHEMIE AG, Munich (DE)

(72) Inventors: Torsten GOTTSCHALK-GAUDIG, Mehring (DE); Sebastian KROENER, Burghausen (DE); Klaus OBERMEIER, Burghausen (DE); Achim SCHNEIDER, Neu-Isenburg (DE)

(73) Assignee: WACKER CHEMIE AG, Munich (DE)

(21) Appl. No.: 16/971,194

(22) PCT Filed: Feb. 23, 2018
(86) PCT No.: PCT/EP2018/054514

§ 371 Date: Aug. 19, 2020

(51) Int. Cl. C01B 33/193; C08K 9/06; C08K 3/36

(52) U.S. Cl. CPC C01B 33/193; C08K 9/06; C08K 3/36; C08K 2201/005; C01P 2006/22; C01P 2006/40; C08K 2201/006; C01P 2006/12

(57) ABSTRACT

Highly redisperisble precipitated silica with no or virtually no coarse fraction is prepared by precipitating silica in an aqueous environment, modifying the silica to introduce hydrophobic groups in a homogeneous manner employing an organosiliconate, at a pH of 8-10 and a defined addition rate based on the BET surface area of the silica, followed by liquid milling.

### CROSS REFERENCE TO RELATED APPLICATIONS

This application is the U.S. National Phase of PCT Appln. No. PCT/EP2018/054514 filed Feb. 23, 2018, the disclosure of 10 which is incorporated in its entirety by reference herein.

### BACKGROUND OF THE INVENTION

### 1. Field of the Invention

The invention relates to a modified precipitated silica, characterized in that the particle size of at least 90% of the particles thereof is not more than 1 μm and the redispersibility thereof, i.e. the ratio of the 1 μm undersize determined by laser diffraction after drying the silica divided by the 1 μm undersize determined by laser diffraction before drying the silica, is at least 0.9, and to a process that is suitable for producing these modified precipitated silicas and that has the particular feature of a combination of a homogeneous in-situ modification of the silica together with high-performance liquid milling, and additionally to the use of these modified precipitated silicas.

### 2. Description of the Related Art

Precipitated silicas are oxides of silicon that are produced on an industrial scale via precipitation processes and used in a wide range of applications. The products from precipitation processes usually do not have the requisite particle size or they need to undergo further drying, wherein the product properties set by production, such as the specific surface area, should be altered as little as possible. Consequently, jet mills or impact mills are commonly used for comminuting or milling silicas, and spray dryers, rack dryers, rotary dryers or nozzle towers for drying them. A typical property of precipitated silicas following the performance of these process steps is their poor dispersibility, which is usually evidenced by a coarse fraction in the particle size distribution.

Established manufacturers of precipitated silicas are increasingly seeking to develop highly dispersible silicas (HD5 types). Typical examples are Ulfcrasil® 5000 GR or Ulfcrasil®7000 GR from Evonik. These silicas are commonly used as reinforcing fillers for automobile tires.

The usual way of achieving easy dispersibility in silicas is to intervene in the precipitation process, as described for example in EP 0 901 986 A1 or EP 1 525 159 A1 from Evonik. These HDS types are characterized by a reduced coarse fraction in the particle size measurement. However, it is not possible to produce products having no coarse fraction in this manner.

As a measure of the dispersibility of a precipitated silica, Evonik, for example, uses the wk coefficient, which is based on the particle size distribution measured by laser diffraction (see for example EP 0 901 986 A1). Evaluation of the scattered-light image of the precipitated silica allows the distribution of the particle sizes to be determined over a wide measurement range of approx. 40 nm-500 μm. The wk coefficient indicates the ratio of the peak height of the uncomminuted, very coarse silica particles, the maximum of which is in the 1-100 μm range, to the peak height of the comminuted particles having particle sizes of 0-1 μm. The very small particles in the latter category give rise to excellent dispersions in rubber compounds. The wk coefficient is thus a measure of the dispersibility of the precipitated silica. The lower the wk coefficient of a precipitated silica, the easier the precipitated silica is to disperse. Measurements of the particle size distribution of easily dispersible comparison silicas from the prior art have yielded wk coefficient values from 3.4 to over 10 (see for example EP 0 901 986 A1).

On the other hand, Evonik in EP 0 901 986 A1 and WO 2004/014797 A1 discloses more easily dispersible precipitated silicas having a wk coefficient of <3.4. However, the measured peak for uncomminuted, very coarse silica particles, and also the plots shown in FIGS. 1-5 of EP 0 901 986 A1 and the stated value of >1 for the wk coefficient, show that the silicas of the invention mentioned therein likewise contain a significant fraction of coarse particles having a particle size maximum in the 1-100 μm range. A bimodal particle size distribution is therefore present here (see for example paragraph [0035] in EP 0 901 986).

EP 1 348 669 A1 also relates to finely dispersed silicas having narrow particle size distributions and to processes for the production thereof. EP 1 348 669 A1 likewise reports a wk coefficient of <3.4 for the disclosed precipitated silicas (see paragraph [0040] b) and specifies that the diameter in 95% of particles is less than 40 μm, but only in 5% is it less than 10 μm (see paragraph [0027]). In other words, this means that 95% of the silica particles have a particle size of more than 10 μm.

EP 0 922 671 A1 from Degussa discloses precipitated silicas that were milled using a classifier mill or a fluidized bed counter-jet mill and have a particle distribution index I<1 (measured with Malvern), where I=(d₉₀−d₁₀)/2·d₅₀. The dimension values d₅, d₁₀, d₅₀, d₉₀ or generally dₓ indicate that x % of the total particles have a particle size less than or equal to the corresponding value, i.e. d₅₀=1 μm means that 50% of the particles have a particle size of less than or equal to 1 μm. Despite milling, the silicas described therein do not meet the requirements of an easily dispersible silica, since, according to FIGS. 1 and 2, there is no significant fraction of particles having a particle size of <1 μm.

The object of the invention is to provide modified precipitated silicas having a particle size distribution with the smallest possible coarse fraction, or none altogether, the coarse fraction being characterized by a particle size of more than 1 μm, and a process for the production thereof.

### SUMMARY OF THE INVENTION

The invention provides a modified precipitated silica, characterized in that the particle size of at least 90% of the particles thereof is 0-1 μm and the redispersibility thereof is at least 0.9, and by a process that is suitable for producing these silicas and has the particular feature of a combination of a homogeneous in-situ modification of the silica together with high-performance liquid milling. This has made it possible to provide modified precipitated silicas having a particle size distribution with a coarse fraction of less than 1%, i.e. in which fewer than 1% of particles are larger than 1 μm.

### DETAILED DESCRIPTION OF THE PREFERRED EMBODIMENTS

The invention thus relates to a modified precipitated silica, characterized in that the particle size of at least 90% of the particles thereof is not more than 1 μm and the redispersibility thereof, i.e. the ratio of the 1 μm undersize determined by laser diffraction after drying the silica divided by the 1 μm undersize determined by laser diffraction before drying the silica, is at least 0.9.

The industrial production of synthetic silicas is carried out mainly via precipitation processes. Silicas produced in this way are termed precipitated silicas. Precipitated silicas are produced from condensable tetra- or polyfunctional silanes, alkoxysilanes, alkyl or alkali metal silicates (water glasses) or colloidal silica particles or solutions by processes known to those skilled in the art, as described for example in U.S. Pat. Nos. 2,657,149, 2,940,830, and 4,681,750.

A major advantage in providing precipitated silicas is that, unlike the considerably more costly pyrogenic silicas, they are an inexpensive product.

The modification, and in particular surface modification thereof, allows a better property profile to be achieved, which is why the modification of silicas is a prerequisite in many applications that require, for example, lower water absorption or higher tensile strength.

Determination of the elemental constituents of the composition of the invention by elemental analysis allows the presence of the elements to be determined. The presence of the elements carbon, oxygen, and silicon can be established and quantified by elemental analysis, i.e. in a combustion analysis in an appropriate analyzer. The percentages by weight of the chemical elements are determined by elemental analysis or CHN analysis in an appropriate analyzer and the empirical formula is calculated therefrom.

Nuclear magnetic resonance spectroscopy can be used to investigate the presence of various [RₓSiO_{(4-x)/2}] units on the solid and to estimate the molar ratios. The substituent R can be identified by ¹³C NMR spectroscopy and the number of substituents x in the [RₓSiO_{(4-x)/2}] units where x=0 to x=4 can be determined by ²⁹Si NMR spectroscopy on the basis of the different shift regions.

According to the invention, the particle size of at least 90%, preferably at least 95%, more preferably at least 99%, and most preferably 100% of the particles of the modified precipitated silica is not more than 1 μm. The particle size is defined here as the size determined by laser-diffraction particle size analysis (measurement by laser granulometry). This method is a measurement of the distribution of the size of solid or liquid particles in a liquid or gaseous medium based on the deflection (diffraction) of the light waves of a laser beam. There are measuring devices available for determining the particle size, for example laser-diffraction measurement systems, laser-diffraction sensors or laser-diffraction particle size analyzers, in which a particle stream consisting of the particles to be measured in a liquid or a gas is transported from the medium transversely through the laser light or a glass cell containing the particles dispersed in a liquid medium is placed in the laser beam. The intensity of the light scattered or diffracted through interaction with the particles and associated angle dependence are determined by detectors. The particle size and particle size distribution can be determined from the angle dependence of the scattered light signal by means of suitable theories. Current commercial laser diffraction analyzers generally employ the so-called Mie theory for analyzing the <1 μm size range and the classical Fraunhofer theory for size classes >1 μm, wherein different light sources may be used for the different size ranges.

The method of dispersion is important to the measured result of the particle size determination. The employed method of the invention is optimized for surface-modified silicas and ensures adequate wetting of the modified silicas and the dispersion thereof.

Preference is given to using ultrasound for dispersion. Ultrasound baths are not suitable for achieving adequate dispersing energies. The use of ultrasonic tips or sonotrodes is therefore preferred.

The measured result of the laser-diffraction particle size analysis is evaluated on the basis of the volume-weighted particle size distribution q³ and the corresponding cumulative distribution curve Q³. The cumulative distribution curve is the cumulative plot of the particle size plot normalized to 100%. The undersize at 1 μm is the value in percent of the cumulative distribution curve Q3 at 1 μm. A value of 100% means that all particles have a particle size of less than or equal to 1 μm.

The dimension values d₅, d₁₀, d₅₀, d₉₀ or generally dₓ indicate that x % of the total particles have a particle size less than or equal to the corresponding value, i.e. d₅₀=1 μm means that 50% of the particles have a particle size of less than or equal to 1 μm.

For the present invention, the determination of the wk coefficient in accordance with WO 2004/014797 as the ratio of the peak height of the particles having a maximum in the 1-100 μm range to the peak height of the particles having a maximum in the <1.0 μm range always gives a value of 0/x=0, where x is the peak height of the particles having a maximum in the <1.0 μm range.

Fundamentally, the wk coefficient is only apparently a reliable measure of particle dispersibility. The problem here is that it is a reflection only of the ratio of the modal value B (=modal value of all particles having a size from 1 μm to 100 μm) to modal value A (=modal value of all particles having a size <1 μm). A wk value of 1 now means, that the peak heights in the two modes are identical. However, this does not necessarily mean that a silica having a wk value of, for example, 4 is more poorly dispersible than a silica having a wk value of 1. Thus, it is entirely possible that with a wk value of 1 there are more particles in the 1 to 100 μm size range than with a wk value of 4. This is always a possibility when there is a strongly distorted particle distribution curve with a pronounced positive (statistical) deviation, i.e. a distribution exhibiting pronounced tailing toward larger particle sizes. A very broad symmetrical distribution about the B modal value can also give rise to a similar effect.

Consequently, for the silicas of the invention, the undersize at 1 μm is chosen here as a measure of the quality of the dispersibility that clearly reflects the relative proportions of the coarse and fine fractions.

The determination of the particle distribution index I in accordance with EP 0 922 671 A1 where I=(d₉₀−d₁₀)/2·d₅₀ is also an unsuitable measure of the dispersibility of silicas, since the numerical value, like the wk value, is only a relative variable and provides no information about the position of the distribution.

In contrast to the precipitated silicas available in the prior art, the modified precipitated silica of the invention is characterized by a small particle size in the range of not more than 1 μm, a very low to absent coarse fraction, i.e. particles having a size of more than 1 μm, and therefore also by a narrow particle size distribution.

It thus has the great advantage that silicone elastomers having better optical properties, in particular having better transparency, are obtainable. Because coarse particles are mostly absent, there are no large scattering centers at which the light passing through is scattered, thereby rendering the component cloudy in appearance.

It also has the advantage that elastomers—and in particular silicone elastomers such as HTV, LSR or RTV rubbers—having better mechanical properties such as modulus, tensile strength or tear resistance are obtainable. The reason is the better and more homogeneous distribution of the silica particles in the polymer matrix, which results in a denser secondary particle network and thus more effective stress relaxation and greater overstraining.

An additional advantage of the modified precipitated silica of the invention is that the better dispersibility results in a greater thickening effect when used as a rheological additive. Another advantage is that, when used as an antiblocking additive or as an anticaking agent, the distribution of the silica particles on the host particles is better, thereby increasing the effectiveness of the silica of the invention.

The silica of the invention with a homogeneous modification layer is characterized inter alia by its excellent redispersibility after drying. The redispersibility of the modified precipitated silica of the invention is at least 0.9, preferably 0.95, more preferably 0.99, and most preferably 1, the redispersibility being defined as the ratio of the 1 μm undersize determined by laser diffraction after drying the silica divided by the 1 μm undersize determined by laser diffraction before drying the silica. A redispersibility of 1 means that the silica is completely redispersible after drying and that ail particles have a particle size of less than 1 μm. The modified precipitated silica of the invention is characterized in that the specific BET surface area thereof is preferably 50 m²/g to 400 m²/g, more preferably 100 m²/g to 300 m²/g, and most preferably 150 m²/g to 250 m²/g.

The specific surface area can be determined by the BET method in accordance with DIN 9277/66131 and 9277/66132.

The modified precipitated silica of the invention is further characterized in that the carbon content thereof is preferably not less than 1.5% by weight, more preferably not less than 2.0% by weight. The carbon content is essentially based on the modification of the precipitated silica with organic radicals.

The carbon content can be determined by elemental analysis, i.e. in a combustion analysis in an appropriate analyzer.

The modified precipitated silica of the invention is further characterized in that the conductivity of a 5% dispersion thereof in methanol-water is preferably not more than 500 S/cm, more preferably not more than 100 S/cm, and most preferably not more than 25 S/cm.

Since modified silicas are poorly wetted by water or not wetted at all, the conductivity of an appropriate sample can be determined in a methanol/water mixture. This is done by mixing a small amount of sample (5 g of the precipitated silica modified according to the invention) with 10 g of methanol and only then diluting with 85 g of demineralized water. To ensure it is homogeneous, the mixture is alternately mixed well and left to stand for a lengthy period. Before the conductivity measurement using a conductivity measuring ceil, the mixture is shaken again. The conductivity can be measured using any conductivity meter. It is determined for a reference temperature of 20° C. Determining the conductivity of a sample is also a very sensitive method for quantifying soluble impurities.

Homogeneous surface modification of the silica is important for a small particle size and in particular for excellent redispersibility of the silica after drying.

The modified precipitated silica is therefore preferably characterized by a homogeneous surface modification.

To assess the homogeneity of the surface modification, a wetting test in combination with a partition test between an aqueous phase and an organic phase has proved useful. In accordance with the invention, preference is given to using n-butanol as the organic phase. Preference is additionally given to using water as the aqueous phase.

When a modified precipitated silica is largely wetted by water after intensive mixing with water and sinks into the aqueous phase causing it to become turbid, the modified precipitated silica is hydrophilic. When, at the same time, this modified precipitated silica in a system consisting of an aqueous phase and an organic phase, which can be e.g. butanol, does not give rise to turbidity in the organic phase, the modified precipitated silica that has been judged to be hydrophilic is at the same time lipophobic. In this case, a homogeneous surface modification is present.

A homogeneous surface modification is also present when a modified precipitated silica is not wetted after intensive mixing with water, i.e. it floats on the aqueous phase and forms a separate phase, i.e. it is hydrophobic, but at the same time gives rise to turbidity in the organic phase in a system consisting of an aqueous phase and an organic phase, i.e. it is lipophilic.

A homogeneous surface modification is likewise present when a modified precipitated silica is not wetted by water after intensive mixing with water, i.e. it floats on the aqueous phase and forms a separate phase, i.e. it is hydrophobic, but is at the same time not wetted by either phase in a system consisting of an aqueous phase and an organic phase, but forms a third, solids-rich phase.

An inhomogeneous surface modification is present when a modified precipitated silica is wetted after intensive mixing with water, i.e. it sinks into the aqueous phase and causes it to become turbid, i.e. it is hydrophilic, but at the same time gives rise to turbidity in the organic phase in a system consisting of an aqueous phase and an organic phase, i.e. it is lipophilic.

A more precise assessment of the homogeneity of the interface is possible by means of inverse gas chromatography at finite concentration (IGC-FC). This method allows the energetic homogeneity of a surface to be determined via the adsorption energy distribution function (AEDF). The AEDF is a graphical plot of the energy distribution of a surface. The silicas modified according to the invention were found to give 3 peaks in the distribution function.

A homogeneous surface modification is preferably characterized in that the relative area fraction F(P3) of peak P3, which is in the range from approx. 28-32 kJ/mol of the AEDF of the modified precipitated silica determined by IGC-FC, is less than 0.2, more preferably less than 0.15, and most preferably less than 0.1. The relative area fraction F(P3) is here defined as F(P3)=A(P3)/[A(P1)+A(P2)+A(P3)], in which A(Px) where x=1, 2 or 3 is the area of peaks P1, P2, and P3. This means that the relative area fraction F(P3) of the high-energy peak P3 preferably has the lowest possible intensity.

The invention further provides a process for producing these modified precipitated silicas in which the modification reaction takes place during or directly after the reaction producing the precipitated silica, characterized in that:
i) modification of the precipitated silica is carried out using more than 0.0075 mmol of organosiliconate per m² BET surface area (specific surface area) of the modified precipitated silica to be produced, measured according to the BET method (in accordance with DIN ISO 9277),
ii) the organosiliconate is metered in at a reaction mixture pH of 8-10 and at a relative rate of addition of less than 5.0 mmol./(min*l), and
iii) the modified precipitated silica is milled in the liquid phase.

The process of the invention is based on the so-called “one-pot process”, in which the modification reaction takes place during or directly after the reaction producing the precipitated silica, as described in detail in WO 2018/019373. In addition to the characteristics of this “one-pot process” described in WO 2018/019373, this invention discloses a defined amount of organosiliconate added, a defined pH range in the reaction in which the organosiliconate is metered in at a defined relative metering rate, and a milling step in the liquid phase.

The process of the invention is preferably composed of the following process steps:
i) adding or forming [SiO_{4/2}] units, more preferably forming [SiO_{4/2}] units
ii) metering in of organosiliconate, i.e. surface modification (in the same mixture)
iii) optionally completing the reaction through a post-reaction
iv) milling in the liquid phase
   a) direct milling of the reaction mixture after step ii and optional step iii or
   b) separating (i.e. separating the solid from the liquid phase, for example by filtration or centrifugation, particularly preferably by filtration), optionally washing, optionally drying, redispersing (particularly preferably in water), and milling the dispersion
v) separating (i.e. separating the solid from the liquid phase, for example by filtration or centrifugation, particularly preferably by filtration)
vi) optionally washing the solid
   washing is particularly preferably carried out during performance of process step iv) a)
   washing is particularly preferably not carried out during performance of process step iv) b)
vii) drying the solid.

The above-mentioned individual steps are basic operations in the production of the silica of the invention. Individual steps may optionally also be combined. For example, step i) and step ii) may also be operated in parallel.

The individual process steps are preferably carried out in succession and more preferably in the order indicated.

Alkoxysilanes or alkali metal silicates (water glasses) are according to the invention used as the starting material (precursor) for the formation of [SiO_{4/2}] units ([SiO_{4/2}]starting material). In the context of this invention, the [SiO_{4/2}] units denote the basic structural units of the precipitated silica; alkoxysilanes or alkali metal silicates serve as the [SiO_{4/2}] starting material for the production thereof.

Particular preference is given to using water glasses as [SiO_{4/2}] starting materials. Water glass refers to glassy, i.e. amorphous, water-soluble sodium, potassium and lithium silicates solidified from a melt or aqueous solutions thereof. Aqueous solutions of sodium water glass are particularly preferred.

[SiO_{4/2}] units denote compounds in which a silicon atom is bonded to four oxygen atoms, which in turn each have a free electron for a further bond. Units bonded via the oxygen atom that have Si—O—Si linkages may be present. The free oxygen atoms are in the simplest case bonded to hydrogen or carbon, or the compounds are present in the form of salts, preferably alkali metal salts.

The reaction for producing a precipitated silica takes place in step (i) of the process for producing a modified precipitated silica. The modification thereof (process step ii) takes place in the same mixture, it being possible for the modification reaction to take place during or directly after the reaction producing the precipitated silica. This means that the modification takes place in the above-described reaction mixture that is used to produce the precipitated silica. This process is in the context of this invention also referred to as a “one-pot process” just as in WO 2018/019373. The “one-pot process” is a clear difference from the prior art, which generally operates on the basis of multistep, separate processes.

The reaction mixture in step i) preferably comprises water, alkali metal silicate, and acid, more preferably water, alkali metal silicate, and sulfuric acid.

According to the invention, siliconate is metered into the reaction mixture for producing the modified precipitated silica in an amount that corresponds to more than 0.0075 mmol, preferably 0.0075 mmol to 1.0 mmol, and more preferably 0.01 mmol to 0.1 mmol, of organosiliconate active substance per m² BET surface area (specific surface area) of the modified precipitated silica to be produced, measured according to the BET method (in accordance with DIN ISO 9277). This means, and is a further particular advantage of the invention, that the amount of organosiliconate active substance may be selected according to the desired specific surface area (BET) of the product.

The molar amount of organosiliconate active substance per m² BET surface area (specific surface area) of the modified precipitated silica can be determined by elemental analysis from the carbon fraction of the modified precipitated silica produced, with the amount of bonded organosiliconate active substance originating from a monomethyl siliconate being calculated using the structural formula CH₃Si(O)_{3/2} for the bonded organosiliconate. In analogous manner, the amount of bonded organosiliconate active substance originating from a dimethyl siliconate is calculated assuming the structural formula (CH₂)₂Si(O)_{2/2} for the bonded organosiliconate active substance. In general, when calculating the amount of active substance for all organosiliconates of the general formula (I) (see below), only half of every oxygen atom directly involved in the modification reaction is taken into account and counterions such as cations are disregarded.

In step i), further substances such as electrolytes and/or alcohols may be added to the reaction mixture. The electrolyte may be a soluble inorganic or organic salt. Preferred alcohols include inter alia methanol, ethanol or isopropanol. In a preferred embodiment, the only further substances added to the reaction mixture in addition to water, alkali metal silicate, and acid are electrolytes and/or alcohols, more preferably only electrolytes are added, and most preferably no further substances at all are added to the reaction mixture.

According to the invention, the modification reaction takes place during or directly after the reaction producing the precipitated silica. According to the invention, “directly” in this context means that modification in the reaction mixture, which comprises 1. acid and 2. the precipitated silica and/or [SiO_{4/2}] starting materials, and 3. an organosiliconate as modifier, takes place without the modification reaction being preceded by a process step to remove salts and/or other by-products. The term “directly” does not mean directly in time; stirring or being left to stand between the steps in the reaction is not excluded. However, according to the invention the modification reaction is not preceded by any ion exchange, filtration, washing, distillation or centrifugation steps or by resuspension.

The omission of a preliminary process step to remove salts and/or other by-products is highly advantageous, since it saves on energy costs, time, and resources such as wash solution/wash water and resuspension solution/water. This approach makes the use of additional apparatus unnecessary. It is of particular economic interest, since the process of the invention saves time and thus reduces plant occupancy time. The other by-products include, inter alia, alcohols.

In the modification or modification reaction, which in the context of this invention is also referred to synonymously with hydrophobization or hydrophobization reaction, the unmodified precipitated silica reacts with organosiliconate as a modifier. The modifier in the context of this invention is accordingly also referred to synonymously with modifying agent, coating agent, hydrophobizing agent or silylating agent.

According to the invention, organosiliconates refer to compounds of the general formula (I)

R¹ₙ—Si(OR²)₄₋ₙ

where R¹, R², and n are defined as follows:
R¹=independently hydrogen, linear or branched, optionally functionalized C₁-C₃₀ alkyl, linear or branched, optionally functionalized C₂-C₂₀ alkenyl, linear or branched, optionally functionalized C₁-C₃₀ alkynyl, optionally functionalized C₃-C₂₀ cycloalkyl, optionally functionalized C₃-C₂₀ cycloalkenyl, optionally functionalized C₁-C₂₀ heteroalkyl, optionally functionalized C₅-C₂₂ aryl, optionally functionalized C₆-C₂₃ alkylaryl, optionally functionalized C₆-C₂₃ arylalkyl, optionally functionalized C₅-C₂₂ heteroaryl,
R²=independently hydrogen, linear or branched, optionally functionalized C₁-C₃₀ alkyl, linear or branched, optionally functionalized C₂-C₃₀ alkenyl, linear or branched, optionally functionalized C₂-C₃₀ alkynyl, optionally functionalized C₃-C₂₀ cycloalkyl, optionally functionalized C₃-C₂₀ cycloalkenyl, optionally functionalized C₁-C₂₀ heteroalkyl, optionally functionalized aryl, optionally functionalized C₆-C₂₃ alkylaryl, optionally functionalized C₆-C₂₃ arylalkyl, optionally functionalized C₅-C₂₂ heteroaryl, NR¹₄⁺, where R¹ may independently be as defined above, M^{p+}ₛ, where M is a metal atom selected from the group consisting of metals from the main groups and subgroups of the periodic table of the elements and p is the oxidation number of the metal atom M, s=1/p, and/or a group of the general formula (IIa)

—SiR¹ₘ(OR²)₃₋ₘ

where R¹ and R² are independently as defined above and m may independently be 0, 1, 2 or 3,
n=1, 2 or 3,
and at least one solvent, optionally at least one surface-active substance or a mixture thereof,
where, in the compound of the general formula (I) or in the group of the general formula (IIa), at least one radical R³ is NR¹₄⁺ or M^{p+}ₛ, where R¹, p, s, and M are as defined above.

When R² in the compound of the general formula (I) represents a group of the general formula (IIa) several times over, for example more than once, this means that corresponding compounds bearing two, three, four or more units containing Si atoms are present. Consequently, when R² represents a group of the general formula (IIa) several times over, polysiloxanes or polysiloxanolates are present.

An organosiliconate must by definition contain at least one Si—C bond, i.e. at least one radical must be organic in nature.

The particular advantage of using organosiliconates as modifiers is that they are highly water-soluble and therefore particularly suitable for a homogeneous reaction in an aqueous medium. The use of an aqueous solution of the otherwise solid or waxy substances simplifies handling, since exact dosing can be achieved relatively easily through the use of pumps.

By contrast, typically used modifiers such as organoalkoxysilanes or organochlorosilanes are poorly soluble in water or not soluble at all. They react violently with water to some degree spontaneously and also highly exothermically, which makes it considerably harder to carry out the reaction safely, smoothly and in a controlled manner (e.g. in the case of organochlorosilanes, which are often used).

According to the invention, mixtures of different organosiliconates may also be used. Preference is given to mixtures when functional groups (for example vinyl, allyl, or sulfur-containing groups such as C₃H₆SH) are to be introduced.

In the process of the invention, preference is given to using methyl siliconates as organosiliconates, more preferably monomethyl siliconates or dimethyl siliconates. Further to the above statement, the use of methyl siliconates is particularly advantageous, because methyl siliconates can be obtained simply and in good yield from readily available and inexpensive methylchlorosilanes, methylmethoxysilanes or methylsilanols by reaction with alkaline substances, optionally in an aqueous medium.

In a particularly preferred embodiment, aqueous solutions of monomethyl siliconates of the general form (CH₂)Si(OH)₃₋ₓOMₓ and oligomeric condensation products thereof are used in which the counterion M is preferably potassium or sodium and x is preferably 0.5-1.5, more preferably 0.8-1.3. In a particularly preferred embodiment, x=0.8-0.9, with x referring not to 1 molecule, but to the totality of the molecules present in the mixture. A particularly preferred organosiliconate is SILRES® BS16 (aqueous potassium methyl siliconate solution, available from Wacker Chemie AG), the organosiliconate active substance content of which is approx. 34% by weight, calculated as CH₃Si(O)_{3/2}.

In an alternative preferred embodiment, aqueous solutions of dimethyl siliconates of the general form (CH₃)₃Si(OH)₂₋ₓOMₓ and oligomeric condensation products thereof are used in which the counterion M is preferably potassium or sodium and x is preferably 0.1-2.0, with x referring not to 1 molecule, but to the totality of the molecules present in the mixture.

Particular preference is given to using aqueous solutions containing any desired mixtures of dimethyl siliconates of the general form (CH₃)₂Si(OH)₂₋ₓOMₓ and oligomeric condensation products thereof and monomethyl siliconates of the general form (CH₃)Si(OH)₃₋ₓOMₓ and oligomeric condensation products thereof, where M and x are as defined above.

Preference is given to using the siliconates without prior isolation or removal of by-products or elimination products. This means that, for example, dimethyldimethoxysilane is reacted directly with the required amount of aqueous potassium hydroxide solution or sodium hydroxide solution and the aqueous solution of dimethyl siliconate thereby obtained is used directly without further purification, for example by removing the methanol that is formed.

Surprisingly, the products of the process have a homogeneous surface modification, with the homogeneity determined as described above.

In step ii, further substances such as electrolytes and/or alcohols may be added to the reaction mixture. The electrolyte may be a soluble inorganic or organic salt. Preferred alcohols include inter alia methanol, ethanol or isopropanol.

The reaction components in step ii are preferably mixed by simple stirring.

The temperature of the reaction mixture in step ii) is preferably 70-95° C., more preferably 90° C.

The organosiliconate, preferably methyl siliconate, may be metered in at the same time as the metering in of the [SiO_{4/2}] starting material, which is most preferably water glass, or after the metering in of the [SiO_{4/2}] starting material, which is most preferably water glass. The organosiliconate, preferably methyl silicate, is preferably metered in after the metering in of the [SiO_{4/2}] starting material, which is most preferably water glass, has ended.

Surprisingly, it was found that the metering rate of the organosiliconate is key to the homogeneity of the surface modification. According to the invention, the organosiliconate is therefore metered in at a reaction mixture pH of 8-10, with a relative metering rate of less than 5.0 mmol/(min*l), preferably 5.0 mmol/(min*l) to 0.5 mmol/(min*l), and more preferably 4.0 mmol/(min*l) to 1.0 mmol/(min*l). The relative metering rate is defined here as the metering rate of the organosiliconate active substance in mmol per minute based on a reaction volume of 1 l, the reaction volume being composed of the volume of demineralized water used and the volume of the solution of the [SiO_{4/2}] starting material, preferably water glass, used.

According to the invention, the organosiliconate is metered in at a reaction mixture pH of 8-10, preferably 8.0-10.0, and more preferably 8.5 to 9.0. To this end, to counteract the alkalinity of the siliconate, acid is preferably added to the reaction mixture, more preferably sulfuric acid or hydrochloric acid, and most preferably concentrated sulfuric acid.

The preferred reaction mixture consisting of water, [SiO_{4/2}] starting material, which is most preferably water glass, acid, which is most preferably sulfuric acid, and organosiliconate, which is most preferably methyl siliconate, and optionally electrolytes and/or alcohols then undergoes post-reaction for a period preferably of 30 minutes to 120 minutes, more preferably of 60 min, i.e. the reaction completes.

During this post-reaction period, the pH is preferably kept constant. This can be achieved by adding more acid to the mixture in the process.

During this post-reaction period, the temperature is also preferably kept constant.

To end the reaction without or after any optional post-reaction period, it is preferably stopped by lowering the pH to approx. 3.5 and/or the temperature to 50° C.

The reaction mixture is then preferably filtered and more preferably washed also. Washing may be carried out using water, polar organic solvents or mixtures thereof; it is preferably carried out with water, more preferably with fully demineralized, deionized water, which is characterized in that it has a conductivity of <5 μS/cm, preferably of <3 μS/cm, and more preferably of ≤0.1 μS/cm.

Washing may be carried out in different ways. For example, the solid separated off by filtration is rinsed with fresh water until a sufficiently low (preferably constant) conductivity value of <500 μS/cm, preferably <100 μS/cm, more preferably <10 μS/cm is attained in the wash water. The wash water may be supplied continuously or in a number of portions. A particularly efficient form of washing is redispersion of the filter cake in clean water followed by a further filtration.

Optionally, the silica may be separated off by centrifugation instead of by filtration.

According to the invention, the modified precipitated silica is milled in the liquid phase in a further process step. This process step can take place before or after a wash.

The liquid phase is preferably an aqueous phase, more preferably water, most preferably demineralized water.

When milling in the liquid phase in accordance with the invention is carried out before washing, the preferred reaction mixture consisting of water, [SiO_{4/2}] starting material, which is most preferably water glass, acid, which is most preferably sulfuric acid, and organosiliconate, which is most preferably monomethyl or dimethyl siliconate, and optionally electrolytes and/or alcohols, is milled directly after the end of the reaction and after any optional post-reaction period and/or lowering of the pH and/or temperature. The silica can then be washed as described above, separated from the liquid phase, and dried.

When milling in the liquid phase in accordance with the invention is carried out after washing, the moist filter cake or centrifugation residue is redispersed in demineralized water and this dispersion is then milled in the liquid phase.

Preferably, the pH of the dispersion can be adjusted before milling to a value of 3 to 10, more preferably 5 to 8. Preparation of the dispersion for milling in the liquid phase in accordance with the invention, i.e. for mixing and dispersion of the modified precipitated silica, may be carried out using conventional mixers or stirrers, such as cross-arm mixers or anchor stirrers, or high-speed dispersers, such as rotor-stator machines, dissolvers, colloid mills or ultrasonic dispersers or high-pressure homogenizers.

The solids content of the dispersion containing the modified precipitated silica before milling is preferably 1% to 50% by weight, more preferably 2% to 20% by weight, and most preferably 5% to 15% by weight. After milling in the liquid phase in accordance with the invention, the dispersion may be dried directly or filtered/centrifuged off, in which case washing may optionally be carried out one or more times, followed by the drying step. Preference is given to subsequent filtration without a further washing step, followed by final drying.

Milling in the liquid phase in accordance with the invention may be carried out using all mills in which the material to be milled is present in a liquid phase. Typical examples are horizontal or vertical ball mills and bead mills, in which milling media are used to comminute the material to be milled. In addition to the collisions between particles and milling media responsible for the comminution effect, in these types of mills large numbers of collisions also occur between individual units of milling media and between milling media and the apparatus wall, which can cause undesired abrasion and wear and associated contamination of the product.

Further typical examples are dispersing units such as rotor-stator apparatuses (colloid mills, gear-rim dispersers), in which the comminution effect is essentially due to shear forces arising from the surrounding fluid, and high-pressure homogenizers, in which the dispersion effect is essentially due to expansion flow, shear flow, turbulence and possibly also to cavitation. Particularly in the case of more viscous dispersions, vertical mills such as roller mills or edge mills are suitable for comminution.

Preference is given to impact mills or autogenous liquid mills (liquid jet dispersers), in which dispersion jets containing the predispersed material to be milled are directed at one another with high kinetic energy or are directed against impact surfaces. Comminution is here based on particle-particle collisions, particle-wall collisions and also on turbulence and possibly cavitation of the surrounding fluid.

Milling is preferably carried out using a liquid jet disperser. The dispersion to be treated is pumped into this by means of high-pressure pumps, for example piston pumps, pressurized to high pressures of up to several thousand bar. The dispersion is then depressurized through an orifice of varying geometry or slits. With the fall in pressure, the liquid jet is strongly accelerated. The liquid jet thus generated can be directed against an impact element in an impact chamber or can be directed at a second liquid jet directed in the opposite direction. On impact, the directed kinetic energy of the jet or jets is reduced by particle collisions, particle-fluid interaction, and by dissipation of energy in the fluid. Comminution of the particles takes place both on passing through the orifice and on impact of the dispersion on the impact surface or the liquid jet directed opposite. It is particularly advantageous when the opposing liquid jets are generated from the same initial dispersion via a common high-pressure pump system and a flow divider that separates the total flow of the dispersion to be treated into two partial flows. In this embodiment, the outlay on equipment is lowest and the wear and associated contamination of the product due to the autogenous comminution process is likewise minimal.

The liquid jet dispersion can be characterized by the following essential parameters:

Specific Energy E:

E is the energy per unit dispersion mass acting on the system through the build-up of pressure that may be harnessed to generate the orifice flow and the jet formation in the impact chamber. The calculation is based on an approximation of Bernoulli's principle, disregarding specific potential energy and specific kinetic energy, since these are negligible by comparison with the contribution from the specific pressure energy in the high-pressure region of the liquid jet dispersion. Thus, E=p/Σ_{disp}, where p is the static pressure in [Pa(abs.)] and ρ_{disp} is the dispersion density in [kg/m³]. The specific energy is preferably greater than 1×10⁴ m²/s², more preferably the specific energy is within a range from 5×10⁴ m²/s² to 1×10⁶ m²/s², and in a particular embodiment the specific energy is within a range from 1×10⁵ m²/s² to 5×10⁵ m²/s².

Average Jet Velocity U in the Orifice Cross Section:

The average flow velocity in the orifice cross-section can be determined from the ratio of the volume flow through the orifice R [m³/s] and the orifice cross-sectional area A_{crifice} [m³]. Thus, u=R/A_{crifice}.

The average jet velocity in the orifice cross section is preferably greater than 10 m/s, more preferably the average jet velocity in the orifice cross section is within a range from 10 m/s to 2000 m/s, in a particular embodiment the average jet velocity in the orifice cross section is within a range from 100 m/s to 1000 m/s.

To improve the milling quality, the material to be milled may preferably be passed through the liquid jet disperser more than once. Most preferably, the material to be milled may be passed through the liquid jet disperser 1 to 20 times and, in a particular embodiment, the material to be milled is passed through the liquid jet disperser 5 to 10 times.

It is preferable when the milled and optionally washed mixture, i.e. the modified precipitated silica, is dried in the next step in the process. The drying temperature is preferably more than 100° C. The drying process is ended when the powder reaches constant weight, i.e. the weight of the powder does not change even after further drying. Drying may be carried out by means of customary industrial methods such as static drying in drying ovens on trays or dynamic drying with passage of the material to be dried through a higher-temperature zone, for example in drum dryers, cone-dryers or fluid-bed (fluidized-bed) dryers. Drying under dynamic conditions is preferred.

Drying is preferably carried out by atomizing an optionally diluted dispersion into a hot air stream, i.e. by spray drying.

It is preferably the BET surface area (specific surface area) of the dried modified precipitated silica according to the BET method (in accordance with DIN ISO 9277) that is measured.

The particle size of preferably at least 90% of the particles of the modified precipitated silica produced is preferably not more than 1 μm. A narrow particle size distribution is preferably present. The coarse fraction having particle sizes of 1-10 μm is preferably not more than 10%, more preferably not more than 5%, and most preferably 0%.

Dried modified precipitated silicas such as Sipernat D10 or Sipernat D17 from Evonik cannot subsequently be milled in the liquid phase, because they are not wetted by water. A dried hydrophilic precipitated silica such as Sipernat D288 is, on the other hand, wetted by water. The redispersibility of the particles after subsequent milling in the liquid phase is however low (see comparative example 4).

The modified precipitated silica of the invention is producible by the process of the invention, particularly preferably the modified precipitated silica of the invention is produced by the process of the invention.

The process of the invention is preferably used to produce the modified precipitated silicas of the invention.

The invention further provides a process for reinforcing elastomers, in which one of the above-described modified precipitated silicas of the invention is incorporated.

The silicas of the invention are particularly highly suitable as reinforcing fillers in elastomers, in particular as reinforcing fillers in silicone elastomers such as silicone solid rubbers (HTV/HCR rubbers) and silicone liquid rubbers (LSR rubbers).

The invention is described in more detail hereinbelow with reference to example embodiments, without being limited thereby.

### Methods of Analysis:

### Determination of BIT Surface Area

The specific surface area was determined by the BET method in accordance with DIN 9277/66131 and 9277/66132 using an SA™ 3100 analyzer from Beckmann-Coulter.

### Determination of the Carbon Content (% C)

Elemental analysis for carbon was carried out according to DIN ISO 10694 using a CS-530 elemental analyzer from Eltra GmbH (D-41469 Neuss).

### Determination of Particle Sixe, Particle Sixe Distribution, and Redispersibility by Laser Diffraction

### Sample Preparation:

### a) Solids:

A 30 ml vial with a snap-on lid was charged with 9.5 g of isopropanol and 0.5 g of the silica to be measured was then added. Any coarse particles present were first crushed with a spatula. The dispersion was thoroughly mixed for approx. 20 minutes using a magnetic stirrer.

4 g of the sample mixture was then added to a solution of 0.3 g of BYK192 in 15.7 g of pH 10 demineralized water (pH adjusted with 1 M aqueous NaOH solution), shaken vigorously several times, and then mixed for a further 20 min on a magnetic stirrer.

The mixture was then dispersed by sonicating for 15 min while stirring gently with a magnetic stirrer. This was done using a Dr. Hilscher OP 400s ultrasound generator with sonotrode 3 at 50% power, with the sonotrode positioned at a distance of approx. 2 cm from the magnetic stirrer bar. A dispersion having a solids content of approx. 0.8% was obtained.

### b) Aqueous Dispersions:

The solids content of the dispersion was determined by drying to constant mass using a commercially available IR solids content balance.

In accordance with the previously determined solids content of the dispersion, the sample was diluted with pH 10 demineralized water (pH adjusted with 1 M aqueous NaOH solution) to a solids content of approx. 0.8%, shaken vigorously several times, and then mixed for 20 min on a magnetic stirrer.

The mixture was then dispersed by sonicating for 15 min while stirring gently with a magnetic stirrer. This was done using a Dr. Hilscher UP 400s ultrasound generator with sonotrode 3 at 50% power, with the sonotrode positioned at a distance of approx. 2 cm from the magnetic stirrer bar.

### Measurement:

The measurement was carried out on a Malvern Mastersizer 3000 laser diffraction apparatus with a Hydro MV wet cell.

The measurement cell was filled with pH 10 demineralized water (pH adjusted with 1 M aqueous NaOH solution) and a background measurement was recorded with a measuring time of 20 s. The sample dispersion described above was then added dropwise until the laser shadow had attained a value of approx. 2-2.5. The measurement temperature was 25° C. Before the actual measurement, the measured dispersion was first stirred at 1800 rpm for 5 min in the measurement cell to ensure uniform mixing. To determine the particle size, three individual measurements were carried out. Between each measurement, the measured dispersion was stirred at 1800 rpm for 5 min. The measurement was each time started immediately after the end of the pre-mixing time.

The following parameters were specified:
Refractive index of the particles: 1.400
Absorbance value of the particles: 0.010
Refractive index of the dispersant: 1.330
Particle type: non-spherical
Measurement time: 20 s

The analysis was carried out according to Mie theory with the aid of the universal analysis model implemented in the software.

The data shown in table 1 are the values for the second individual measurement, it being necessary to ensure that the difference in the d₅₀ values in the individual measurements was <5%.

Table 1 lists the undersize at 1 μm and the redispersibility.

The measured result of the laser-diffraction particle size analysis was evaluated on the basis of the volume-weighted particle size distribution q³ and the corresponding cumulative distribution curve Q³. The cumulative distribution curve is the cumulative plot of the particle size plot normalized to 100%. The undersize at 1 μm is the value in percent of the cumulative distribution curve Q3 at 1 μm. A value of 100% means that all particles have a particle size of less than or equal to 1 μm.

In the determination of redispersibility, both the silica dispersion after liquid milling without prior separation or drying and the dried powder after liquid milling were measured. The redispersibility is the ratio of the 1 μm undersize after drying the silica divided by the 1 μm undersize before drying the silica. A redispersibility of 1 means that the silica is completely redispersible after drying and that all particles have a particle size of less than 1 μm.

### Determination of the Homogeneity of the Surface Modification

### Test 1:

A 50 ml vial with a snap-on lid was charged with 25 ml of demineralized water. 100 mg of the silica powder to be investigated was then added and the vial was closed and shaken vigorously for 30 s.

### Assessment:

Hydrophilic: The silica was largely wetted and sank into the aqueous phase.
Hydrophobic: The silica was largely unwetted and did not sink. It floated on the aqueous phase and formed a separate phase.

### Test 2:

A 50 ml vial with a snap-on lid was charged with 15 ml of demineralized water and 15 ml of butanol. 100 mg of the silica powder to be investigated was then added and the vial was closed and shaken vigorously for 30 s. After phase separation, the partition of the particles in the two phases is optically assessed.

### Assessment:

Lipophilic: The upper butanol phase was strongly turbid, the lower aqueous phase was largely clear.
Lipophobic: The upper butanol phase was largely clear, the lower aqueous phase was strongly turbid.

### Determination of Homogeneity:

| | | Possibility 1 | Possibility 2 | Possibility 3 | Possibility 4 |
|---|---|---|---|---|---|
| Assessment of | Test 1 | Hydrophilic | Hydrophilic | Hydrophobic | Hydrophobic |
| the silica | Test 2 | Lipophilic | Lipophobic | Lipophilic | Lipophobic* |

| | | | | |
|---|---|---|---|---|
| Determination of homogeneity | Not | homogeneous | homogeneous | homogeneous |
| | homogeneous | | | |

*In this case, a third, solid-rich phase formed between the aqueous phase and the butanol phase.

### Determination of the BET Constant C_{BET} and of the Adsorption Energy Distribution Functions

The determination was carried out by inverse gas chromatography at finite concentration (IGC-FC). For this purpose, a non-rusting chromatography column having an inner diameter of 2 mm and a length of 15 cm was filled with the silica to be investigated. The sample amount was approx. 190 mg. The two ends of the column were closed with silanized glass wool. The packed column was connected to the gas chromatograph by means of ⅛′ Swagelok connectors. The gas chromatograph was a standard commercial apparatus with FID detector. The carrier gas used was helium. Before measurement, the sample was degassed for 16 h at 110° C. and a gas flow rate of 12 ml/min. The subsequent measurement was carried out at 50° C. and a gas flow rate of 20 ml/min. For this, 1.5 to 3.0 μl of isopropanol (purity of at least GC quality) was typically injected using a 10 μl syringe. The amount of sample injected needed to be determined iteratively. The aim was to achieve a maximum peak height at a relative pressure of 0.1 to 0.25. This could be determined only from the overall chromatogram.

To determine the dead volume, methane was injected together with isopropanol.

The isotherm for determining the BET constant C_{BET} were calculated according to Conder (“Physicochemical measurement by gas chromatography”. J. R. Conder and C. L. Young. Wiley (Chichester), 1979). The adsorption energy distribution functions (AEDF) were determined according to Balard (H. Balard; “Estimation of the Surface Energetic Heterogeneity of a Solid by Inverse Gas Chromatography”; Langmuir, 13 (5), pp. 1260-1269, 1997). The isotherm and physical parameters/AEDF derived therefrom were calculated using the “In-Pulse”® and “FDRJ07.5.F”® software from Adscientis.

To determine the area fraction of the high-energy peak of the AEDF, the distribution function was broken down into the individual peaks by peak deconvolution. This was done by reading the raw AEDF data into the ORIGIN program and carrying out deconvolution assuming a Gaussian distribution for the individual peaks. For all the examples mentioned herein, the best fit was obtained assuming 3 peaks with the following peak positions: P1 approx. 17-19 kJ/mol, P2 approx. 21-25 kJ/mol, and P3 approx. 28-32 kJ/mol. Table 1 shows the area fraction of the high-energy peak F(P3)=A(P3)/[A(P1)+A(P2)+A(P3)] in the 28-32 kJ/mol range, in which A(Px) where x=1, 2 or 3 is the area of peaks P1, P2, and P3.

### Raw Materials Usad:

Aqueous sodium silicate solution: commercial water glass 38/40 from Wöllner having a density at 20° C. of approx. 1.37 g/cm³ according to the manufacturer's data.

Potassium methyl siliconate solution: aqueous potassium methyl siliconate solution Silres© BS16 having an active substance content, calculated as CH₃Si(O)_{3/2}, of approx. 34% by weight according to the manufacturer's data.

### Example 1

18 kg of demineralized water was heated to 90° C. in a 40 L universal stirrer unit (steel/enamel) equipped with a propeller paddle stirrer. While stirring at 250 min⁻¹, 5.04 kg of water glass was metered in at this temperature over a period of 60 min at a constant metering rate. In parallel to this, 1.22 kg of 50% sulfuric acid was metered in at the same time, resulting in the maintenance of a broadly constant pH (pH approx. 8.5). The mixture was stirred at 90° C. for a further 5 min and then, with continued stirring at 90° C., 0.59 kg of an aqueous potassium methyl siliconate solution at a relative metering rate of 2.3 mmol/(min*l) and 0.29 kg of 50% sulfuric acid (pH approx. 8.5) were added over a period of 60 min. The mixture was stirred further at 90° C. and pH 8.5 for 1 h and was then acidified to pH 3.5 by adding 50% sulfuric acid with stirring. After cooling to 50° C., the solid was filtered off through a chamber filter press using K100 filter plates and washed until pH-neutral. The moist filter cake was redispersed in 20 kg of demineralized water using a paddle stirrer and the resulting dispersion was milled at a solids content of approx. 7.6% by weight on a Starburst 10 autogenous liquid mill with water from Sugino as propellant. The material to be milled was passed through the mill four times at a specific energy input of 224 565 m²/s² (ρ_{disp}=1091 kg/m³) per run, with an orifice upstream pressure of 2450 bar and an average suspension velocity in the orifice cross section of 490 m/s, and at a throughput of 40 l/h.

The silica was filtered off through a chamber filter press using K100 filter plates and blown dry with nitrogen. The filter cake was dried to constant weight on trays in a drying oven at 150° C. The solid was then analyzed as described in the methods of analysis. The results are shown in tab. 1.

### Example 2

18 kg of demineralized water was heated to 90° C. in a 40 L universal stirrer unit (steel/enamel) equipped with a propeller paddle stirrer. While stirring at 250 min⁻¹, 5.04 kg of water glass was metered in at this temperature over a period of 60 min at a constant metering rate. In parallel to this, 1.22 kg of 50% sulfuric acid was metered in at the same time, resulting in the maintenance of a broadly constant pH (pH approx. 8.5). The mixture was stirred at 90° C. for a further 5 min and then, with continued stirring at 90° C., 1.54 kg of an aqueous potassium methyl siliconate solution at a relative metering rate of 2.4 mmol/(min*l) and 0.77 kg of 50% sulfuric acid (pH approx. 8.5) were added over a period of 110 min. The mixture was stirred further at 90° C. and pH 8.5 for 1 h and was then acidified to pH 3.5 by adding 50% sulfuric acid with stirring. After cooling to 50° C., the solid was filtered off through a chamber filter press using K100 filter plates and washed until pH-neutral. The moist filter cake was redispersed in 20 kg of demineralized water using a paddle stirrer and the resulting dispersion was milled at a solids content of approx. 7.6% by weight on a Starburst 10 autogenous liquid mill with water from Sugino as propellant. The material to be milled was passed through the mill eight times at a specific energy input of 224 565 m²/s² (ρ_{disp}=1091 kg/m³) per run, with an orifice upstream pressure of 2450 bar and an average suspension velocity in the orifice cross section of 490 m/s, and at a throughput of 40 l/h. The silica was filtered off through a chamber filter press using K100 filter plates and blown dry with nitrogen. The filter cake was dried to constant weight on trays in a drying oven at 150° C. The solid was then analyzed as described in the methods of analysis. The results are shown in tab. 1.

### Comparative Example 3 (Noninventive)

17 kg of demineralized water was heated to 90° C. in a 40 L universal stirrer unit (steel/enamel) equipped with a propeller paddle stirrer. While stirring at 250 min⁻¹, 5.21 kg of water glass was metered in at this temperature over a period of 60 min at a constant metering rate. In parallel to this, 1.21 kg of 50% sulfuric acid was metered in at the same time, resulting in the maintenance of a broadly constant pH (pH approx. 9.0). The mixture was stirred at 90° C. for a further 5 min and then, with continued stirring at 90° C., 0.659 kg of an aqueous potassium methyl siliconate solution at a relative metering rate of 12.3 mmol/(min*l) and 0.30 kg of 50% sulfuric acid (pH approx. 8.5) were added over a period of 13 min. The mixture was stirred further at 90° C. and pH 9.0 for 1 h and was then acidified to pH 3.5 by adding 50% sulfuric acid with stirring. After cooling to 50° C., the solid was filtered off through a chamber filter press using K100 filter plates, washed until pH-neutral, and blown dry with nitrogen. The filter cake was dried to constant weight on trays in a drying oven at 150° C. and, after cooling to room temperature, milled on a 2PS50 classifier mill from Hosokawa-Alpine (mill: 20 000 min⁻¹; classifier: 16 000 min⁻¹).

A portion of the dry-milled silica was redispersed in demineralized water with a paddle stirrer to a 7.5% dispersion and 250 ml of the dispersion was milled on a Starburst Mini laboratory autogenous liquid mill with propellant water from Sugino. The material to be milled was passed through the mill seven times at a specific energy input of 183 486 m²/s² (ρ_{disp}=1090 kg/m³) per run, with an orifice upstream pressure of 2000 bar and an average suspension velocity in the orifice cross section of 120 m/s, and at a throughput of 5 l/h. It was then dried to constant weight in a drying oven at 150° C. The solid was then analyzed as described in the methods of analysis. The results are shown in tab. 1.

### Comparative Example 4 (Noninvantiva)

75 g of a hydrophilic precipitated silica (available from Evonik as Sipernat 288) was dispersed in 0.925 kg demineralized water with a paddle stirrer and 250 ml of the dispersion was milled on a Starburst Mini laboratory autogenous liquid mill with propellant water from Sugino. The material to be milled was passed through the mill five times at a specific energy input of 183 486 m²/s² (ρ_{disp}=1090 kg/m³) per run, with an orifice upstream pressure of 2000 bar and an average suspension velocity in the orifice cross section of 120 m/s, and at a throughput of 5 l/h. It was then dried to constant weight in a drying oven at 150° C. The solid was then analyzed as described in the methods of analysis. The results are shown in tab. 1.

### Example 5

18 kg of demineralized water was heated to 90° C. in a 40 L universal stirrer unit (steel/enamel) equipped with a propeller paddle stirrer. While stirring at 250 min⁻¹, 5.04 kg of water glass was metered in at this temperature over a period of 60 min at a constant metering rate. In parallel to this, 1.22 kg of 50% sulfuric acid was metered in at the same time, resulting in the maintenance of a broadly constant pH (pH approx. 8.5). The mixture was stirred at 90° C. for a further 5 min and then, with continued stirring at 90° C., 0.59 kg of an aqueous potassium methyl siliconate solution at a relative metering rate of 2.3 mmol/(min*l) and 0.29 kg of 50% sulfuric acid (pH approx. 8.5) were added over a period of 60 min. The mixture was stirred further at 90° C. and pH 8.5 for 1 h and was then acidified to pH 3.5 by adding 50% sulfuric acid with stirring. After cooling to 50° C., the solid was filtered off through a chamber filter press using K100 filter plates, washed until pH-neutral, and blown dry with nitrogen. The filter cake was dried to constant weight on trays in a drying oven at 150° C. and, after cooling to room temperature, milled on a ZPS50 classifier mill from Hosokawa-Alpine (mill: 20 000 min⁻¹; classifier: 16 000 min⁻¹).

A portion of the milled silica was redispersed in demineralized water with a paddle stirrer to a 7.5% dispersion and 250 ml of the dispersion was milled on a Starburst Mini laboratory autogenous liquid mill with propellant water from Sugino. The material to be milled was passed through the mill seven times at a specific energy input of 183 486 m²/s² (ρ_{disp}=1090 kg/m³) per run, with an orifice upstream pressure of 2000 bar and an average suspension velocity in the orifice cross section of 120 m/s, and at a throughput of 5 l/h. It was then dried in a drying oven at 150° C. The solid was then analyzed as described in the methods of analysis. The results are shown in tab. 1.

TABLE 1

| | | Specific surface | | | | |
|---|---|---|---|---|---|---|
| | | area of the metal | 1 μm | | | |
| | C content | oxide (BET) | undersize | Re- | Surface | |
| Example | [%] | [m²/g] | [%] | dispersibility | homogeneity | F (P3) |
| 1 | 2.7 | 163 | 100 | 1 | homogeneous | 0.07 |
| 2 | 4.7 | 118 | 100 | 1 | homogeneous | 0.02 |
| 3 | 2.3 | 180 | 97.9 | 0.04 | not homogeneous | 0.60 |
| 4 | — | 142 | 100 | 0.39 | — | 0.51 |
| 5 | 2.6 | 161 | 100 | 1 | homogeneous | 0.005 |

1.-11. (canceled)

12. A modified precipitated silica comprising silica particles, wherein
i) the particle size of at least 90% of the silica particles is not more than 1 μm and
ii) the redispersibility of the modified precipitated silica, which is the ratio of 1 μm undersize fraction determined by laser diffraction after drying the silica divided by a 1 μm undersize fraction determined by laser diffraction before drying the silica, is at least 0.9,
where the undersize at 1 μm is defined as the value in percent of the cumulative distribution curve Q³ at 1 μm.

13. The modified precipitated silica of claim 12, wherein the specific BET surface area is 50 m²/g to 400 m²/g.

14. The modified precipitated silica of claim 12, wherein the carbon content is not less than 1.5% by weight.

15. The modified precipitated silica of claim 12, wherein the conductivity of a 5% dispersion thereof in methanol-water is not more than 500 S/cm.

16. The modified precipitated silica of claim 12, having a homogeneous surface modification.

17. The modified precipitated silica of claim 12, wherein the relative area fraction F(P3) of a peak P3, which is in the range of approx. 28-32 kJ/mol of the AEDF of the modified precipitated silica determined by IGC-FC, is less than 0.2.

18. A process for producing modified precipitated silica of claim 12, comprising modifying precipitated silica particles during or directly after a reaction producing the precipitated silica particles, wherein:
i) modification of the precipitated silica is carried out using more than 0.0075 mmol of organosiliconate active substance per m² BET specific surface area of the modified precipitated silica to be produced, measured according to the BET method in accordance with DIN ISO 9277,
ii) the organosiliconate is metered in at a reaction mixture pH of 8-10 and at a relative rate of addition of less than 5.0 mmol/(min*l), and
iii) the modified precipitated silica is milled in the liquid phase.

19. The process of claim 18, wherein potassium methyl siliconate is used as an organosiliconate.

20. The process of claim 12, wherein the solids content of the dispersion comprising the modified precipitated silica before milling is 1% to 50% by weight.

21. The process of claim 19, wherein milling is carried out using a liquid jet disperser.

22. A process for reinforcing elastomers, comprising incorporating a modified precipitated silica of claim 12 into the elastomer as a filler.
